(19) United States
(12) Patent Application Publication
(10) Pub. No.: US 2014/0356767 A1
(43) Pub. Date: Dec. 4, 2014

(54) CARBON FIBER COMPOSITE, METHOD FOR PRODUCING SAME, CATALYST SUPPORT AND POLYMER ELECTROLYTE FUEL CELL

(71) Applicant: Toppan Printing Co., Ltd., Tokyo (JP)

(72) Inventors: Mitsuharu KIMURA, Tokyo (JP); Yumiko OOMORI, Tokyo (JP); Takuya ISOGAI, Tokyo (JP)

(21) Appl. No.: 14/458,046

(22) Filed: Aug. 12, 2014

Related U.S. Application Data
(63) Continuation of application No. PCT/JP2013/000784, filed on Feb. 13, 2013.

(30) Foreign Application Priority Data
Feb. 15, 2012 (JP) 2012-030481

(51) Int. Cl. H01M 4/88

(52) U.S. Cl. CPC H01M 4/8803; H01M 4/88; H01M 2008/1095
USPC 429/532; 427/115

(57) ABSTRACT

An improved catalyst support can be provided by a process for producing a carbon fiber composite which comprises: a step of subjecting metal fine particles of either at least one metal or a compound containing the metal to reductive deposition on fine cellulose having carboxyl groups on the crystal surface to make a composite composed of both the fine cellulose and the metal fine particles; and a step of carbonizing the fine cellulose of the composite to prepare a carbon fiber composite. The invention also relates to a carbon fiber composite made by the process, a catalyst support, and a polymer electrolyte fuel cell.

### CROSS-REFERENCE TO RELATED PATENT APPLICATIONS

This application is a continuation application filed under 35 U.S.C. §111(a) claiming the benefit under 35 U.S.C. §§120 and 365(c) of PCT International Application No. PCT/JP2013/000784 filed on Feb. 13, 2013, which is based upon and claims the benefit of priority of Japanese Application No. 2012-030481 filed on Feb. 15, 2012, the entire contents of which are hereby incorporated by reference in their entireties.

### BACKGROUND OF THE INVENTION

1. Technical Field

The invention relates to a carbon fiber composite, a method for producing the same, a catalyst support and a polymer electrolyte fuel cell.

2. Background Art

Cellulose is a noteworthy eco-friendly material. Cellulose is contained in cell walls of plants, exocrine secretions from microbes, mantles of sea squirts, etc., and is the most common polysaccharide on earth. Cellulose has biodegradability, high crystallinity and excellent stability and safety.

Oxidized cellulose fibril is obtained by performing an oxidation reaction with a 2,2,6,6-tetramethylpiperidine-1-oxyl (TEMPO)-based catalyst. In the oxidized cellulose fibril, only the primary hydroxyl group at the C6 position of three hydroxyl groups, which cellulose on a crystalline surface has, can be selectively converted to a carboxyl group through an aldehyde group. Additionally, the reaction is feasible under relatively mild conditions such as of an aqueous system or at room temperature.

It is known that the obtained oxidized cellulose fibril can be dispersed in water as fine cellulose by suspending in water and adding a slight mechanical treatment. Fine cellulose has relatively high strength due to its high crystallinity and low linear expansion coefficient, and has carboxyl groups on the surface thereof in high density

On the other hand, recently, attention has been paid to fuel cells as the next-generation of clean energy systems. The fuel cell is an electrical power generation system in which reacting hydrogen and oxygen at a pair of electrodes including catalyst layers generates electricity with heat, the reaction being a reverse reaction of electrolysis of water. The electrical power generation system is characterized in that efficiency is high comparing with the conventional power generation method, that the environment load is also low because of no emission of greenhouse effect gas etc. such as carbon dioxide, further that no noise occurs, and so on. There are some varieties of fuel cells depending on types of ion conductors that are used, and a cell using an ion-conducting polymer membrane is called a polymer electrolyte fuel cell.

For an electrode catalyst of the polymer electrolyte fuel cell, carbon particles supporting very fine platinum particles etc. thereon have been used. If the size of the platinum fine particles becomes too large because of aggregation etc., the cell made from the electrode catalyst cannot show enough performance. In addition, the supply of platinum is estimated at about 80000 tons in total worldwide amount, and at about 3000 yen/g in price, platinum is a rare noble metal. Accordingly, an improved method for preparing platinum fine particles and supporting them efficiently on a carbon substrate becomes desirable. However, it is noted that the present invention can be applied not only to platinum but to other metal fine particles consisting of one or more types of metals or compounds thereof being supported on at least a surface of carbon fibers.

In order to improve this, for example, in Patent Literature 1, an oxidant is added to platinum complex compound aqueous solution, which is obtained by dissolving sodium hydrogen sulfite with chloroplatinic acid aqueous solution, to generate colloidal particles as oxidation products, followed by regulating pH with a hydrogen peroxide aqueous solution to deposit on conductive carbon, thereby preparing carbon supporting catalyst. According to this method, however, platinum fine particles are deposited randomly on carbon, therefore because of poor dispersibility the platinum does not function efficiently as a catalyst. In Patent Literature 2, an insulating resin cover layer such as of acetylcellulose or ethylcellulose is formed on a surface of an aggregate containing carbon particles supporting catalysts and an ion-conducting electrolyte, thereby preventing aggregation or dissolution of catalysts. In this method, however, since catalysts are covered with the insulating resin, catalytic function is deteriorated, therefore the platinum still cannot be utilized efficiently.

### CITATION LIST

### Patent Literature

[PTL 1] Japanese Patent No. 3368179

[PTL 2] Japanese Patent Application Publication No. 2010-238513

### SUMMARY OF THE INVENTION

### Technical Problem

Prior catalyst supports have a problem where, even if carbon particles are made to support platinum fine particles thereon, aggregation etc. prevents uniform dispersion of the fine size particles, therefore catalytic function cannot be provided efficiently.

The invention has been made in view of those circumstances and has as its object the provision of a material able to support metal fine particles more disperability and even densely, a method for producing the same, a catalyst support, and a polymer electrolyte fuel cell.

### DETAILED DESCRIPTION OF THE PREFERRED EMBODIMENTS

### Description of Some Embodiments

A first embodiment of the invention is a carbon fiber composite, characterized in that metal fine particles consisting of one or more types of metals or compounds thereof are supported on at least a surface of carbon fibers.

A second embodiment of the invention is the carbon fiber composite defined in the above first embodiment, characterized in that the carbon fibers are formed by carbonizing fine cellulose having a carboxyl group on the crystalline surface thereof.

A third embodiment of the invention is the carbon fiber composite defined in the above second embodiment, characterized in that carboxyl groups are introduced on crystalline surfaces of the fine cellulose by oxidation reaction with an N-oxyl compound wherein an amount of the carboxyl groups of the fine cellulose is from not less than 0.1 mmol/g to not more than 3.0 mmol/g.

A fourth embodiment of the invention is the carbon fiber composite defined in the above second embodiment, characterized in that the fine cellulose has a number average fiber width of not less than 1 nm to not larger than 50 nm and a number average fiber length of not less than 100 to not larger than 10000 times the number average fiber width.

A fifth embodiment of the invention is the carbon fiber composite defined in the above second embodiment, characterized in that fine cellulose has crystallinity of 50% or more, and has a crystal structure of cellulose type I.

A sixth embodiment of the invention is the carbon fiber composite defined in the above first or second embodiment, characterized in that a particle size of the metal fine particle is from not less than 1 nm to not larger than 50 nm.

A seventh embodiment of the invention is a method for producing a carbon fiber composite, characterized by comprising the steps of: preparing a fine cellulose-metal fine particle composite by reducing metal fine particles consisting of one or more types of metals or compounds thereof to deposit on fine cellulose having carboxyl groups on the crystalline surface thereof; and preparing a carbon fiber composite by carbonizing fine cellulose part of the fine cellulose-metal fine particle composite.

An eighth embodiment of the invention is a catalyst support characterized by using the carbon fiber composite defined in any one of the above first to sixth embodiments.

An ninth embodiment of the invention is a polymer electrolyte fuel cell characterized by using the catalyst support defined in the above eighth embodiment.

### Advantageous Effects of Invention

A carbon fiber composite of the invention can be used as a material able to support metal fine particles.

Further, according to a producing method of the invention, metal fine particles can be reduced to deposit selectively on carboxyl groups of fine cellulose without a step, such as for mixing conductive carbon and metal fine particles separately, or for surface-modifying metal fine particles with an insulating substance. This can prevent at least some aggregation of metal fine particles due to sintering etc., which enables metal fine particles to be supported more densely on carbon fibers.

In addition, because metal fine particles can be supported on carbon fibers with good dispersibility, reducing the amount of metal fine particles without a significant decrease in catalyst efficiency becomes possible, which enables cost to decrease.

A carbon fiber composite of the invention has the above characteristics, therefore is useful to a catalyst support and a polymer electrolyte fuel cell using the same.

### More Detailed Description of Embodiments

The invention is now described further in detail, by using as an example an embodiment using fine cellulose as carbon fibers.

### (Fine Cellulose Having a Carboxyl Group on a Crystalline Surface Thereof and the Producing Method Therefor)

Fine cellulose of the invention has a carboxyl group on a crystalline surface thereof. The amount of carboxyl groups is preferably from not less than 0.1 mmol/g to not larger than 3.0 mmol/g. From not less than 0.5 mmol/g to not larger than 2.0 mmol/g is more preferable. If the amount of the carboxyl groups is less than 0.1 mmol/g, there is a concern that no electrostatic repulsion occurs and thus, a difficulty is involved in uniformly dispersing the fine cellulose. Over 3.0 mmol/g, there is also concern that the crystallinity of fine cellulose decreases.

It is preferred that the fine cellulose of the invention has an number average fiber width ranging from not less than 1 nm to not more than 50 nm and that the average fiber length ranges from 100 to 10000 times the number average fiber width. If the number average fiber width is less than 1 nm, there is a concern that the cellulose is not broken into as nanofibers. Over 50 nm, there is a concern that the carbon fiber composite does not show sufficient catalytic function. If the number average fiber length is less than 100 times the number average fiber width, there is a concern that, when metal fine particles are deposited on fine cellulose, the fine cellulose may be precipitated by metal fine particles depositing thereon, because of low viscosity. Conversely, over 10000 times the number average fiber width, there is a concern that the viscosity of the dispersion becomes too high, with concern that a problem arises in dispersability.

Fine cellulose preferably has crystallinity of 50% or more, and preferably has a crystalline structure of type I. Having crystallinity of 50% or more is preferred because a fine structure can be formed with the crystalline structure inside. Having the crystalline structure of type I is preferred, because then celluloses having high crystallinity derived from natural products can be used.

A method for producing fine cellulose having a carboxyl group on the crystalline surface, according to the invention, is described.

Fine cellulose having carboxyl group on the crystalline surface used in the invention is obtained by the steps of oxidizing cellulose, and reducing the cellulose into fine pieces to obtain a dispersion.

### (Cellulose Oxidizing Step)

As a starting material of cellulose to be oxidized, the starting material can be wood pulp, non-wood pulp, recycled waste pulp, cotton, bacterial cellulose, valonia cellulose, ascidian cellulose, microcrystal cellulose, etc.

For the oxidation of cellulose, several techniques can be used. However, it is preferred to use a technique wherein a co-oxidant is used in the presence of an N-oxyl compound, which has higher selectivity to the conversion of primary hydroxyl groups to carboxyl groups while keeping the structure to the possible extent under aqueous, relatively mild conditions. As the N-oxyl compound, some examples of suitable compounds, aside from 2,2,6,6-tetramethylpiperidine-N-oxyl (TEMPO), include:
2,2,6,6-tetramethyl-4-hydroxypiperidine-1-oxyl,
2,2,6,6-tetramethyl-4-phenoxypiperidine-1-oxyl,
2,2,6,6-tetramethyl-4-benzylpiperidine-1-oxyl,
2,2,6,6-tetramethyl-4-acryloyloxypiperidine-1-oxyl,
2,2,6,6-tetramethyl-4-methacryloyloxypiperidine-1-oxyl,
2,2,6,6-tetramethyl-4-benzoyloxypiperidine-1-oxyl,
2,2,6,6-tetramethyl-4-cinnamoyloxypiperidine-1-oxyl,
2,2,6,6-tetramethyl-4-acetylaminopiperidine-1-oxyl,
2,2,6,6-tetramethyl-4-acryloylaminopiperidine-1-oxyl,
2,2,6,6-tetramethyl-4-methacryloylaminopiperidine-1-oxyl,
2,2,6,6-tetramethyl-4-benzoyloylaminopiperidine-1-oxyl,
2,2,6,6-tetramethyl-4-cinnamoylaminopiperidine-1-oxyl,
4-propionyloxy-2,2,6,6-tetramethylpiperidine-N-oxyl,
4-methoxy 2,2,6,6-tetramethylpiperidine-N-oxyl,
4-ethoxy-2,2,6,6-tetramethylpiperidine-N-oxyl,
4-acetamido-2,2,6,6-tetramethylpiperidine-N-oxyl,
4-oxo-2,2,6,6-tetramethylpiperidine-N-oxyl,
2,2,4,4-tetramethylazetidine-1-oxyl,
2,2,-dimethyl-4,4-dipropylazetidine-1-oxyl,
2,2,5,5-tetramethylpyrrolidine-N-oxyl,
2,2,5,5-tetramethyl-3-oxopyrrolidine-1-oxyl,
2,2,6,6-tetramethyl-4-acetoxypiperidine-1-oxyl,
di tert-butylamine-N-oxyl, and,
poly[(6-[1,1,3,3-tetramethylbutyl]amino)-s-triazine-2,4-diyl][(2,2,6,6-tetramethyl-4-piperidyl)imino]hexamethylene[(2,2,6,6-tetramethyl-4-piperidyl)imino.
   Of these, 2,2,6,6-tetramethyl-1-piperidine-N-oxyl and the like are preferably used.

As the above-mentioned co-oxidant, any co-oxidants such as halogen, hypohalous acid, halous acid, perhalous acid, salts thereof, halogen oxides, nitrogen oxides and peroxides may be used so far as they are able to promote the oxidation reaction. Of these, sodium hypochlorite is preferred in view of the ease in availability and reactivity.

When carried out in co-existence with a bromide or iodide, the oxidation reaction can be advanced smoothly. Thus, the introduction efficiency of carboxyl groups can be improved.

As an N-oxyl compound, TEMPO is preferred and its amount may be enough to function as a catalyst. As a bromide, sodium bromide or lithium bromide is preferred, of which sodium bromide is more preferred in view of cost and stability. The amount of the co-oxidant, bromide or iodide may be one capable of promoting the oxidation reaction. It is preferred that the reaction is performed under conditions of a pH range of about 9-11. As the oxidation proceeds, carboxyl groups are formed to lower the pH in the system, for which it is necessary to keep the system at a pH of 9-11.

To keep the system alkaline, adjustment can be made such that an alkali aqueous solution is added while keeping the pH relatively constant. For the alkali aqueous solution, there can be used sodium hydroxide, lithium hydroxide, potassium hydroxide or ammonia aqueous solution, or an organic alkali such as tetramethylammonium hydroxide, tetraethylammonium hydroxide, tetrabuthylammonium hydroxide or benzyltrimethylammonium hydroxide. Sodium hydroxide is preferred in view of cost, etc.

In order to terminate the oxidation reaction, it is necessary that the reaction of the co-oxidant is fully finished by the addition of another type of alcohol while keeping the pH of the system. As an alcohol to be added, low-molecular-weight alcohols such as methanol, ethanol and propanol are preferred in order to complete the reaction immediately. Ethanol is more preferable in view of the safety of by-products formed by the reaction, etc.

As a method of washing the cellulose (oxidized cellulose) after completion of the oxidation, mention is made of a method of washing while leaving a salt formed with an alkali as it is, a method of washing after addition of an acid for conversion into carboxylated form, a method of washing after addition of an organic solvent for greater insolubilization. It is preferred from the standpoint of handleability, yield and the like to use the method of washing after addition of an acid for conversion into carboxylated form. As a washing solvent, water is preferred.

### (The Step of Downsizing Cellulose to Make a Dispersion)

For a method of downsizing oxidized cellulose, the oxidized cellulose is initially suspended in water, various types of organic solvents such as an alcohol, or mixed solvents thereof. If needed, the pH of the dispersion may be adjusted so as to enhance dispersability. For an alkali aqueous solution used for the pH adjustment, mention is made of sodium hydroxide, lithium hydroxide, potassium hydroxide, an ammonia aqueous solution, and organic alkalis such as tetramethylammonium hydroxide, tetraethylammonium hydroxide, tetrabuthylammonium hydroxide and benzyltrimethylammonium hydroxide. Of these, sodium hydroxide is preferred in view of cost and ease in availability, etc.

Subsequently, for physical defibration, the size reduction can be performed by representative methods such as using a high-pressure homogenizer, an ultrahigh-pressure homogenizer, a ball mill, a roll mill, a cutter mill, a planetary mill, a jet mill, an attritor, a grinder, a juicer-mixer, a homomixer, a ultrasonic homogenizer, a nanogenizer, an aqueous counter collision, etc. By performing the defibration process over an arbitrary time or by an arbitrary number of repetitions, a dispersion of an aqueous solution of fine cellulose (oxidized fine cellulose) having a carboxyl group on its surfaces can be obtained.

The dispersion aqueous solution of oxidized fine cellulose may, as necessary, contains components other than cellulose and the component used for the pH adjustment within ranges not impairing the effect of the invention. Other types of components are not limited specifically and can be appropriately selected from known additives depending on the usage of fine cellulose and the like. Specifically, mention is made of organometallic compounds such as alkoxysilanes or hydrolysates thereof, inorganic layered compounds, inorganic acicular minerals, leveling agents, antifoaming agents, water-soluble polymers, synthetic polymers, inorganic particles, organic particles, lubricants, antistats, ultraviolet absorbers, dyes, pigments, stabilizers, magnetic powders, orientation accelerators, plasticizers, and cross-linkers, etc.

### (The Step of Making Oxidized Fine Cellulose Surfaces to Support Metal Fine Particles Consisting of Metals or Compounds Thereof)

As metal fine particles to be supported on the oxidized fine cellulose surface, although there is no specific limitation, metal fine particles having catalytic function are preferred, and there may be, for example, platinum group elements such as platinum, palladium, ruthenium, iridium, rhodium and osmium, metals such as gold, silver, iron, lead, copper, chrome, cobalt, nickel, manganese, vanadium, molybdenum, gallium and aluminum, alloys, oxides or multiple oxides thereof. As methods for making the oxidized fine cellulose surface to support metal fine particles, there is no specific limitation, a method in which a solution of the metal, alloy, oxide, multiple oxide and the like and the dispersion aqueous solution of oxidized fine cellulose are mixed, thereby interfacing anionic carboxyl groups on the oxidized fine cellulose surface and cations of metal, alloy, oxide, multiple oxide and the like electrostatically to reduce and deposit is preferred for making the oxidized fine cellulose surface to support the metal fine particles densely. As methods for reducing the metal, alloy, oxide or multiple oxide, although there is no specific limitation, methods using weak reductants, which are simple and easy to use to control particle size to be small and equal, are preferred. As reductants, there may be metallic hydrides, such as sodium borohydride, potassium borohydride, lithium aluminium hydride, sodium cyanoborohydride, lithium trialkoxyaluminiumhydride and diisobutylaluminiumhydride, and sodium borohydride is preferred in view of safety and general versatility.

### (The Step of Carbonizing Oxidized Fine Cellulose-Metal Fine Particle Composite, Thereby Preparing a Carbon Fiber Composite)

Although methods for carbonizing an oxidized fine cellulose-metal fine particle composite is not limited specifically, the temperature for the carbonization only has to be a temperature where oxidized fine cellulose is partially or fully carbonized, from not less than 300° C. to not larger than 3000° C. is preferred, from not less than 600° C. to not larger than 2000° C. is further preferred. In partial carbonization, carboxyl groups on the oxidized fine cellulose particle surface remain, which allows metal fine particles to regioselectively arrange easily, thereby being able to reduce an effect of sintering. Therefore, the partial carbonization is more effective. The carbon fiber composites made by carbonizing the oxidized fine cellulose-metal fine particle composites may be crushed to reduce size thereof, as needed.

### (Preparing a Polymer Electrolyte Fuel Cell)

In the step of preparing the polymer electrolyte fuel cell, at first, the carbon fiber composite, an ion-exchange resin having protonic conductivity and a solvent are mixed, thereby preparing a coating solution for a catalyst layer. As the ion-exchange resin, there may be used a film made of especially perfluoro-based sulfonic acid polymer, such as, by product names, Nafion (trade mark of Du Pont), Flemion (trade mark of Asahi Glass Co., LTD.), Aciplex (trade mark of Asahi Kasei Corporation) and the like. Further, there may be also used hydrocarbon-based electrolyte, such as sulfonated PEEK (polyetheretherketone), PES (polyethersulfone) and PI (polyimide). As the solvent, although there is no specific limitation, there are used alcohols, such as methanol, ethanol, 1-propanol, 2-propanol, 1-buthanol, 2-buthanol, isobutylalcohol, tert-butylalcohol and pentanol, ketone based solvent, such as acetone, methylethylketone, pentanone, methylisobutylketone, heptanone, cyclohexanone, methylcyclohexanone, acetonylacetone and diisobutyl ketone, ether-based solvent, such as tetrahydrofuran, dioxane, diethyleneglycol dimethyl ether, anisole, methoxytoluene and dibutyl ether, or polar solvents, such as dimethylformamide, dimethylacetamide, N-methylpyrrolidone, ethylene glycol, diethylene glycol, diacetone alcohol and 1-methoxy-2-propanol. A mixture of two or more of these solvents may be used, too.

Subsequently, a substrate is coated with the prepared coating solution for the catalyst layer, followed by drying. Although a thickness of the coated film is not limited specifically, coating only has to be performed such that the thickness becomes within a range generally adopted as the catalyst layer of the polymer electrolyte fuel cell. For example, from not less than 1 μm to not larger than 100 μm is preferred. As the substrate, there is no specific limitation, there may be used a separator, a GDL, glass, a polymer film, such as of polyimide, polyethylene terephthalate, polyparabanic acid aramid, polyamide, polysulfone, polyethersulfone, polyethersulfone, polyphenylenesulfide, polyetheretherketone, polyetherimide, polyacrylate and polyethylene naphthalate, a heat-resistant fluorine resin, such as ethylene tetrafluoroethylene copolymer (ETFE), tetrafluoroethylene-hexafluoropropylene copolymer (FEP), tetrafluoro perfluoroalkylvinylether copolymer (PFA) and polytetrafluoroethylene (PTFE), too.

Although there is no specific limitation, an electrolyte layer only has to be an ion-exchange resin, and there may be used a film made of especially perfluoro-based sulfonic acid polymer, such as, by product names, Nafion (trade mark of Du Pont), Flemion (trade mark of Asahi Glass Co., LTD.), Aciplex (trade mark of Asahi Kasei Corporation) and the like. There may be also used hydrocarbon-based electrolyte, such as sulfonated PEEK (polyetheretherketone), PES (polyethersulfone) and PI (polyimide).

Although a thickness of the electrolyte layer is not limited specifically, coating only has to be performed such that the thickness becomes within a range generally adopted as the electrolyte layer of the polymer electrolyte fuel cell. For example, from not less than 10 μm to not larger than 500 μm is preferred.

In preparing a membrane electrode assembly, a pair of substrates on which the catalyst layers are formed are disposed to sandwich the electrolyte layer from its both sides such that each catalyst layer contacts the electrolyte layer, thereafter are stuck by hot pressing etc., followed by removing the substrates, thereby it can be prepared.

In preparing the polymer electrolyte fuel cell, both surfaces of the membrane electrode assembly are sandwiched with a pair of gas diffusion layers, followed by sandwiching further with a pair of known separators, thereby the polymer electrolyte fuel cell can be prepared.

### EXAMPLES

Hereinafter, the invention is described on the basis of representative examples. It will be noted that the scope of the invention is not limited to these embodiments or example.

### Example 1

### <TEMPO Oxidation of Cellulose>

30 g of soft wood bleached kraft pulp was suspended in 1800 g of distilled water, followed by adding a solution dissolving 0.3 g of TEMPO and 3 g of sodium bromide in 200 g of distilled water and cooling to 20° C. 172 g of an aqueous solution of sodium hypochlorite having a concentration of 2 mol/l and a density of 1.15 g/ml was added drop by drop to commence the oxidation reaction. The system was invariably kept at a temperature of 20° C. and was continuously maintained at pH 10 against the lowering of pH during the reaction by addition of an aqueous solution of sodium hydroxide having a concentration of 0.5 mol/l. When sodium hydroxide reached 2.85 mmol/g relative to the weight of cellulose, enough ethanol was added so as to stop the reaction. Subsequently, hydrochloric acid was added until the pH reached 1, followed by washing well with distilled water repeatedly to obtain oxidized cellulose.

### Measurement of Carboxyl Groups in the Oxidized Cellulose

0.1 g, on solid weight basis, of the oxidized cellulose obtained by the above TEMPO oxidization was taken and dispersed in water at a concentration of 1%, followed by adding hydrochloric acid to make a pH of 3. Thereafter, the amount of the carboxyl groups (mmol/g) was measured by a conductometric titration method by use of 0.5 mol/l of sodium hydroxide aqueous solution. The results were found to be at 1.6 mmol/g.

### <Mechanical Fibrillation of Oxidized Cellulose>

1 g of the oxidized pulp obtained by the above-described TEMPO oxidation was dispersed in 99 g of distilled water, followed by adjustment of pH to 10 by using a sodium hydroxide aqueous solution. The prepared dispersion was subjected to treatment for reducing size by means of a juicer-mixer for 60 minutes to obtain a 1 wt % aqueous dispersion of oxidized fine cellulose.

The shape of the above oxidized fine cellulose was observed through atomic force microscopy (AFM). Ten fiber heights were measured and averaged to provide a number average fiber width. As to the fiber length, similar observation with tapping AFM was made to measure ten fiber lengths along its major length and an average thereof was taken as a number average fiber length. The number average fiber width was at 3.5 nm and the number average fiber length was at 1.3 μm.

### <Preparing a Carbon Fiber Composite>

The above aqueous dispersion of oxidized fine cellulose and 5 mmol/l of chloroplatinic acid aqueous solution were mixed, and stirred sufficiently. Thereafter, 10 mmol/l of sodium borohydride was added to reduce chloroplatinic acid, thereby making oxidized fine cellulose to support platinum fine particles thereon to prepare an oxidized fine cellulose-platinum fine particle composite aqueous dispersion.

For measuring size of the above platinum fine particles, when observation was performed through a transmission electron microscope (TEM), the particle size was at 2 nm.

Next, the oxidized fine cellulose-platinum fine particle composite aqueous dispersion was freeze-dried, thereafter the obtained oxidized fine cellulose-platinum fine particle composite was heated at 1000° C., thereby carbonizing it to prepare the carbon fiber composite.

### <Preparing a Polymer Electrolyte Fuel Cell>

The obtained carbon fiber composite and Nafion were dispersed such that the mass ratio became 2:1. A mixed solvent of methanol and ethanol with 1:1 was used as the solvent. A PTFE sheet was coated with the obtained solution such that platinum support amount was 0.3 mg/cm², and dried.

The above assemblies where the catalyst layers were formed on the PTFE sheets were disposed to face a Nafion film having a thickness of 25 μm, and were hot-pressed by sandwiching under a condition of 130° C. and 6 MPa. The PTFE sheets on both sides were removed, thereafter both side surfaces were sandwiched with carbon cloths and separators, thereby a polymer electrolyte fuel cell of Example 1 was prepared.

### Example 2

A polymer electrolyte fuel cell of Example 2 was prepared in the same way as Example 1, except, in the TEMPO oxidation of the above Example 1, the additive amount of sodium hydroxide was 1.5 mmol/g, and the amount of carboxyl groups of the obtained oxidized cellulose was 1.3 mmol/g.

### Example 3

A polymer electrolyte fuel cell of Example 3 was prepared in the same way as Example 1, except, in the TEMPO oxidation of the above Example 1, the additive amount of sodium hydroxide was 4.0 mmol/g, and the amount of carboxyl groups of the obtained oxidized cellulose was 1.9 mmol/g.

### Example 4

A polymer electrolyte fuel cell of Example 4 was prepared in the same way as Example 1, except, in the preparation of the carbon fiber composite of the above Example 1, the concentration of chloroplatinic acid aqueous solution was 2.5 mmol/l, and the size of the supported platinum fine particle was 1 nm.

### Example 5

A polymer electrolyte fuel cell of Example 5 was prepared in the same way as Example 1, except, in the preparation of the carbon fiber composite of the above Example 1, the concentration of chloroplatinic acid aqueous solution was 10 mmol/l, and the size of the supported platinum fine particle was 4 nm.

### Example 6

A polymer electrolyte fuel cell of Example 6 was prepared in the same way as Example 1, except, in the preparation of the carbon fiber composite of the above Example 1, the carbonization temperature of the oxidized fine cellulose-platinum fine particle composite was at 800° C.

### Comparative Example 1

Platinum support carbon of 50 mass % in platinum support amount and Nafion were dispersed such that the mass ratio became 2:1 respectively. A mixed solvent of methanol and ethanol in 1:1 proportion was used as the solvent. A PTFE sheet was coated with the obtained solution such that platinum support amount was 0.3 mg/cm², and dried.

The above assemblies where the catalyst layers were formed on the PTFE sheets were disposed to face a Nafion film having a thickness of 25 μm, and were hot-pressed by sandwiching under a condition of 130° C. and 6 MPa. The PTFE sheets on both sides were removed, thereafter both side surfaces were sandwiched with cloths and separators, thereby a polymer electrolyte fuel cell of Comparative example 1 was prepared.

### Comparative Example 2

A polymer electrolyte fuel cell of Comparative example 2 was prepared in the same way as Example 1, except, in the preparation of the carbon fiber composite of the above Example 1, the carbonization temperature of fine cellulose-platinum composite was at 250° C. (cellulose did not become carbon fibers, since the carbonization temperature was too low).

### Evaluation of Cell Performance

Regarding the polymer electrolyte fuel cells, the voltage at electrical current density of 0.3 A/cm² was compared.

TABLE 1

| | Cell voltage (V) |
|---|---|
| Example 1 | 1.05 |
| Example 2 | 0.89 |
| Example 3 | 1.11 |
| Example 4 | 1.14 |
| Example 5 | 0.88 |
| Example 6 | 0.83 |
| Example 7 | 1.19 |
| Comparative | 0.72 |
| example 1 | |
| Comparative | 0.21 |
| example 2 | |

As shown in the results of Table 1, carbon fibers were allowed to support platinum fine particles thereon in high density, and to serve the catalytic function efficiently with a small support amount.

What is claimed is:

1. A carbon fiber composite comprising metal fine particles consisting of one or more types of metals or compounds thereof being supported on at least a surface of carbon fibers.

2. The carbon fiber composite of claim 1, wherein the carbon fibers are formed by carbonizing fine cellulose having a carboxyl group on at least a portion of the crystalline surface thereof.

3. The carbon fiber composite of claim 2, wherein the carboxyl groups are introduced on crystalline surfaces of the fine cellulose by an oxidation reaction with an N-oxyl compound.

4. The carbon fiber composite of claim 2, wherein an amount of the carboxyl groups of the fine cellulose is from not less than 0.1 mmol/g to not more than 3.0 mmol/g.

5. The carbon fiber composite of claim 2, wherein the fine cellulose has a number average fiber width of not less than about 1 nm to not larger than about 50 nm and a number average fiber length of not less than about 100 to not larger than about 10000 times the number average fiber width.

6. The carbon fiber composite of claim 2, wherein the fine cellulose has a crystallinity of 50% or more, and has a crystal structure of cellulose type I.

7. The carbon fiber composite of claim 1, wherein a particle size of the metal fine particle is from not less than about 1 nm to not larger than about 50 nm.

8. The carbon fiber composite of claim 1, wherein the metal fine particle consists of platinum.

9. A method for producing a carbon fiber composite, comprising the steps of:
(a) preparing a fine cellulose-metal fine particle composite by reducing a metal fine particle consisting of one or more types of metals or compounds thereof to deposit on fine cellulose having carboxyl groups on the crystalline surface thereof; and,
(b) preparing a carbon fiber composite by carbonizing the fine cellulose part of the fine cellulose-metal fine particle composite.

10. The method of producing a carbon fiber composite of claim 9 further comprising in step (a) performing an oxidation reaction with a 2,2,6,6-tetramethylpiperidine-1-oxyl (TEMPO)-based catalyst.

11. The method of producing a carbon fiber composite of claim 10 further comprising a co-oxidant used in the presence of an N-oxyl compound, wherein the co-oxidant has higher selectivity to the conversion of primary hydroxyl groups to carboxyl groups while keeping the structure to the possible extent under aqueous, relatively mild conditions.

12. A catalyst support comprising the carbon fiber composite of claim 1.

13. A polymer electrolyte fuel cell comprising the catalyst support of claim 12.
